(19) United States
(12) Patent Application Publication
(10) Pub. No.: US 2025/0002792 A1
(43) Pub. Date: Jan. 2, 2025

(54) Duty Recovery System and Process for Steam Cracking Furnace

(71) Applicant: ExxonMobil Chemical Patents Inc., Baytown, TX (US)

(72) Inventors: Mark A. Rooney, Pasadena, TX (US); Jie Yang, Aiken, SC (US); Richard Young, Chicago, IL (US); David Spicer, Houston, TX (US); William A. Aslaner, League City, TX (US)

(21) Appl. No.: 18/706,646

(22) PCT Filed: Nov. 22, 2022
(86) PCT No.: PCT/US2022/080302

§ 371 Date: May 1, 2024

Related U.S. Application Data
(60) Provisional application No. 63/290,261, filed on Dec. 16, 2021.

(51) Int. Cl. C10G 9/36; B01J 19/00; C10G 9/20

(52) U.S. Cl. CPC C10G 9/36; B01J 19/0013; C10G 9/20; B01J 2219/00092; C10G 2300/4081; C10G 2400/20

(57) ABSTRACT

A steam cracking process is provided, including introducing a. first hydrocarbon-containing feed to a convection section of a steam cracking furnace. The convection section can include (i) a first arrangement having a first heat exchanger and a first economizer disposed downstream or upstream, of the first heat exchanger: (ii) a second arrangement having a. second heat exchanger in fluid communication with the first heat exchanger and. a second economizer in fluid communication with the first economizer, the second arrangement disposed downstream of the first arrangement such that each of the first and second economizer alternates with each of the first and second heat exchangers. The process can include (a) heating the first hydro-carbon-containing feed in the first heat exchanger at a hydrocarbon outlet temperature and (b) introducing water to the first economizer and removing the water from the convection section at an outlet temperature.

### CROSS-REFERENCE TO RELATED APPLICATION

This application claims priority to and the benefit of U.S. Provisional Application No. 63/290,261 having a filing date of Dec. 16, 2021, the disclosure of which is incorporated herein by reference in its entirety.

### FIELD

Embodiments of the present disclosure generally relate to methods and systems for cracking hydrocarbons. In particular, the present disclosure relates to managing furnace temperatures.

### BACKGROUND

Steam cracking refers to a commercial process for the production of light olefins, such as ethene and propene. In typical steam cracking processes, the hydrocarbon feed is first preheated and mixed with dilution steam in the convection section of the furnace. After preheating in the convection section, the vapor feed/dilution steam mixture is rapidly heated in the radiant section to achieve thermal cracking of hydrocarbons. After a predetermined amount of thermal cracking occurs, the furnace effluent is rapidly quenched in either an indirect heat exchanger or by the direct injection of a quench oil stream.

A byproduct of the cracking process includes carbon deposits, referred to as “coke,” on the inner surfaces of the radiant tubes of the furnace. Depending on the feed being cracked, coke may also be deposited in certain tubes in the convection section, or in the quench system of the furnace. Decoking operations can impact cracking throughput. Increasing time between decoking by preventing coke accumulation and increasing hydrocarbon conversion involves selective and controlled heating and cooling of portions of the steam cracking furnace. Controlled heating typically uses high amounts of energy from the furnace which is at least partially released from the furnace. Moreover, steam cracking furnaces have different operating conditions depending on the type of feed, processing rates, rate of fouling, and environmental considerations. Furnaces should be flexible to handle different steam rates and different flue gas rates for different convection duties.

There is a need for methods and systems capable of providing temperature control of portions of the furnace, efficiently promoting conversion of hydrocarbons, and reducing furnace emissions for a variety of feeds.

### SUMMARY

In at least one embodiment, a method a steam cracking process is provided. The process can include introducing a first hydrocarbon-containing feed to a convection section of a steam cracking furnace. The convection section can include a first arrangement having a first heat exchanger and a first economizer disposed downstream or upstream of the first heat exchanger. The convection section can include a second arrangement having a second heat exchanger in fluid communication with the first heat exchanger and a second economizer in fluid communication with the first economizer, the second arrangement disposed downstream of the first arrangement such that each of the first and second economizer alternates with each of the first and second heat exchangers. The process can include heating the first hydrocarbon-containing feed in the first heat exchanger, the first hydrocarbon-containing feed exiting the convection section at a hydrocarbon outlet temperature. The process can include introducing water to the first economizer. The process can include removing the water from the convection section at a water outlet temperature. The process can include introducing a hot flue gas from a radiant section of the steam cracking furnace to the convection section.

In another embodiment, a process of designing a steam cracking furnace is provided. The process can include simulating a processing of a hydrocarbon-containing feed in a convection section of a steam cracking furnace. The convection section can include a plurality of heat exchangers and one or more heat recovery exchangers alternating with each of the heat exchangers, one or more of the heat exchangers comprising a first cooling fluid, and one or more of the heat recovery exchangers including a second cooling fluid. The process can include simulating a heating of the convection section with a hot flue gas from a radiant section of the steam cracking furnace. The hot flue gas provides heat to the heat exchangers and the one or more heat recovery exchangers. The process can include selecting a hydrocarbon outlet temperature for at least one heat exchanger of the plurality of heat exchangers and an outlet temperature for at least one of the one or more heat recovery exchangers. The process can include determining an arrangement of the plurality of heat exchangers and the one or more heat recovery exchangers based on the hydrocarbon outlet temperature and the outlet temperature of the one or more heat recovery exchangers.

In another embodiment, a steam cracking furnace is provided. The steam cracking furnace includes a convection section and a radiant section downstream of the convection section. The convection section can include a first heat exchanger in fluid communication with a first section of a line. The convection can include a second heat exchanger in fluid communication with the first section of the line and a second section of the line. The convection can include a first economizer disposed in a first location between the first heat exchanger and the second heat exchanger, the first economizer in fluid communication with a water source. The convection section can include a second economizer disposed in a second location downstream of the second heat exchanger, the second economizer in fluid communication with the first economizer.

In another embodiment, a system for processing hydrocarbons is provided. The system includes a convection section and a radiant section downstream of the convection section. The system is configured to flow flue gas from the radiant section through the convection section. The convection section includes a first economizer in fluid communication with a boiler water feed. A second economizer can be in fluid communication with the first economizer and a steam drum. The system can include a first heat exchanger in fluid communication with a hydrocarbon source. The first heat exchanger can be disposed between the first economizer and the second economizer. The system can include a second heat exchanger in fluid communication with the first heat exchanger, the second heat exchanger can be disposed downstream of the second economizer.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 depicts an apparatus in accordance with an embodiment of the present disclosure.

FIG. 2 depicts a flow diagram of an example method for processing hydrocarbons, in accordance with an embodiment of the present disclosure.

FIG. 3 depicts a flow diagram of an example method for designing a steam cracking furnace, in accordance with an embodiment of the present disclosure.

FIG. 4 depicts temperature duty curves for various effluents of a steam cracking furnace for a crude cracking feed, in accordance with an embodiment of the present disclosure.

FIG. 5 depicts the corresponding LMTD curves, in accordance with an embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

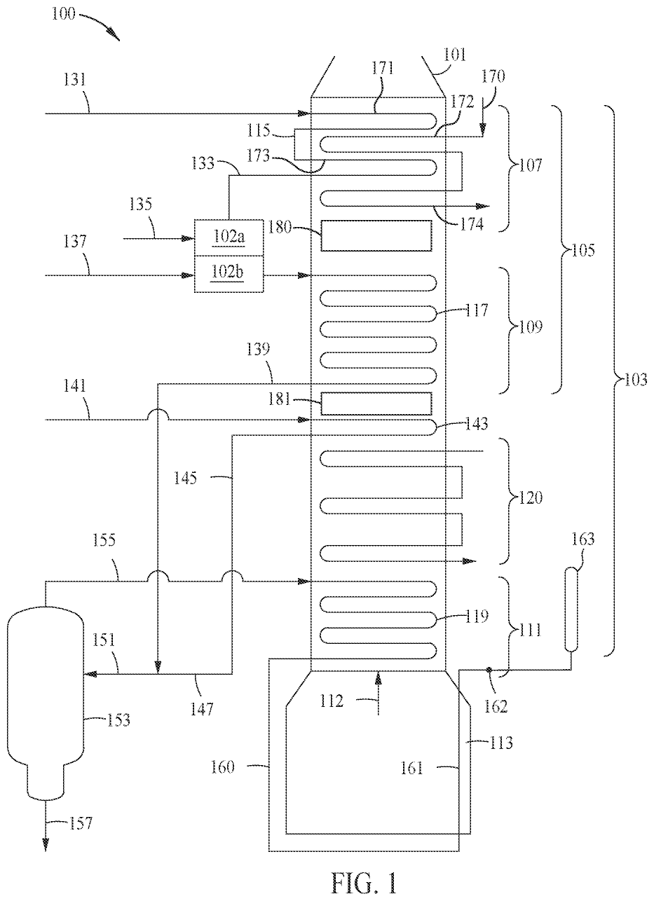

The present disclosure provides methods and systems for flexible, sustainable, and efficient cracking of hydrocarbons. In particular, the present disclosure provides methods and systems for managing temperature constraints of steam cracking furnaces. The hydrocarbon pyrolysis reactor (also referred to as a furnace) used in the present disclosure includes a convection section and a radiant section. As used herein, a convection section can be described as the portion of the furnace where a feed can be treated by convection heating. For example, convection heating, as used herein, can be the indirect heat exchange of hot flue gas from the radiant section, in passages having heat conducting surfaces, such as a bank of metal tubes. The convection section can include one or more convection zones, each zone having an inlet to and an outlet from the convection section. A convection section can include one or more heating zones, as well as a preheating zone which preheats feeds in a heat exchanger using heated bottoms from a vapor liquid separator. Each convection zone can be associated with a tube bank for effecting heat exchange. As used herein, the terms “downstream” and “upstream” refer to a relative position along the furnace in a flow direction of hydrocarbon and/or water/steam through tubing, but (e.g., as shown in FIG. 1) the terms do not require flow of the hydrocarbon and/or water/steam through a single, continuous tubing.

Saturated steam taken from a steam drum can be superheated in a high pressure steam superheater bank. The term “superheat” refers to heating a vapor steam under pressure above the steam's condensation point to provide a temperature above saturation or condensation. By way of example, at atmospheric pressure, water can be heated to about 100° C., then boiled to produce saturated steam, the saturated steam can be further heated to about 200° C. to produce superheated steam. It has been found that superheated steam is useful in the processes described herein because it does not immediately condense as it passes through cold piping or equipment. In some embodiments, for high pressure steam applications that supply power (e.g., ethylene plant or power plant), the water can be heated from about 120° C. supply at a pressure greater than 10 MPa to about 300° C. for boiling and then the saturated vapor is sent through a superheater heat exchanger to provide the additional superheat to the vapor. To achieve a desired turbine inlet steam temperature at all furnace operating conditions, two or more fluid sources can inject fluid into the high pressure steam superheater bank. As used herein, the term “high pressure steam” refers to steam having pressure of about 3.5 MPa to about 5 MPa, the term “super high pressure steam” refers to steam having pressure greater than “high pressure steam”, such as a pressure of about 5 MPa to about 12.5 MPa, such as about 9 MPa to about 11 MPa. The fluid sources can be injected at high pressure steam superheater banks disposed in an alternated arrangement between piping of the multiple heat exchangers arranged in series. The superheater outlet temperature can be controlled at a substantially constant temperature, independent of furnace load changes, coking extent changes, excess oxygen level changes, and/or other variables. The superheater can maintain the temperature of the high pressure steam at about 300° C. or greater, such as about 370° C. to about 590° C., such as about 425° C. to about 590° C. and/or gauge pressure at about 4 MPa to about 12 MPa, such as about 6 MPa to about 10 MPa, such as about 7 MPa to about 9 MPa to provide a reliable amount of superheat for the steam exceeding about 50° C. The fluid sources can inject water into some parts of the system through flow control valve(s) and water atomizer nozzle(s). After heating, the high pressure steam can exit the convection section and a fine mist of water can be added and rapidly vaporized to reduce the steam temperature in the convection section. The high pressure steam can return to the convection section to be further heated and exit for other uses in the production facility (e.g., ethylene production facility). The amount of water added to the superheater can control the temperature of the steam.

To enhance the ability to control coking of the feed stock streams in the tube bank, and capture waste heat, the high pressure steam superheater can be located in the convection section. Since the superheater is located within the furnace flue/convection section, it can act to superheat steam for running other process and steam turbines, and also to quench the furnace flue gas, as needed. In some embodiments, the water added to the superheater can maintain a stack temperature below about 150° C. In some embodiments, the water added to the superheater can withdraw waste heat in the flue gas flowing through the convection section to maintain a stack temperature below about 150° C.

The terms “convert,” “converting,” “crack,” and “cracking” are defined broadly herein to include any suitable molecular decomposition, breaking apart, conversion, dehydrogenation, and/or reformation of hydrocarbon or other organic molecules, by means of at least pyrolysis heat, and can optionally include supplementation by one or more processes of catalysis, hydrogenation, diluents, stripping agents, and/or related processes.

Hydrocarbon-containing feed that can be processed using the methods and systems described herein can include recycle gas such as ethane, steam cracked oil/residue admixtures, gas oils, heating oil, jet fuel, diesel, kerosene, gasoline, coker naphtha, steam cracked naphtha, catalytically cracked naphtha, hydrocrackate, reformate, raffinate reformate, Fischer-Tropsch liquids, Fischer-Tropsch gases, natural gasoline, distillate, crude oil such as heavy crude oil, light virgin naphtha (LVN), atmospheric pipestill bottoms, vacuum pipestill streams including bottoms, wide boiling range naphtha to gas oil condensates, heavy non-virgin hydrocarbon streams from refineries, vacuum gas oils, heavy gas oil, naphtha contaminated with crude, atmospheric residue, heavy residue, hydrocarbon gas/residue admixtures, hydrogen/residue admixtures, liquid petroleum gas (LPG), and mixtures thereof.

Unless otherwise stated, all percentages, parts, ratios, etc., are by weight. Unless otherwise stated, a reference to a compound or component includes the compound or component by itself, and/or the compound or component in combination with other compounds or components, such as mixtures of compounds. Further, when an amount, concentration, or other value or parameter is given as a list of upper values and lower values, this is to be understood as specifically disclosing all ranges formed from any pair of an upper value and a lower value, regardless of whether ranges are separately disclosed.

FIG. 1 depicts an apparatus 100 in accordance with some aspects of the present disclosure. The heating of the hydrocarbon-containing feed 131 can take any suitable form, such as heating by indirect contact of the hydrocarbon-containing feed in a convection section 103 of a furnace 100 as shown in FIG. 1. The convection section 103 can include a first preheating zone 105 with a first and second bank of convection tubes 115, 117. The first bank of convection tubes 115 can be disposed at a first pre-heating section 107 of the first pre-heating zone 105 and the second bank of convection tubes 117 can be disposed substantially adjacent the first bank of convection tubes 115 at a second pre-heating section 109 of the first preheating zone 105. The hydrocarbon-containing feed disposed within line 131 can be fed into the first bank of convection tubes 115 and heated by convection with hot flue gases through furnace 100 in direction 112 from the radiant section 113 that passes through the convection section 103 over each bank of convection tubes (e.g., 115, 117). The hydrocarbon-containing feed of line 131 at the inlet of the first bank of convection tubes 115 can have a temperature of about 20° C. to about 300° C. such as about 25° C. to about 250° C., such as about 25° C. to about 100° C., such as about 32° C. to about 65° C., or 150° C. to about 250° C. (e.g., in some crude applications), and/or a pressure of about 790 kPa to about 1825 kPa, such as about 800 kPa to about 1800 kPa, such as about 800 kPa to about 1000 kPa, alternatively about 1000 kPa to about 1800 kPa.

One or more (e.g., each) of the tube banks can have multiple, parallel-flow systems of tubes, not merely a single tube within the furnace, e.g., as described in U.S. Pat. No. 3,365,387, which is incorporated herein by reference. Thus, any one or more than one flow path can be isolated by appropriate valving, thereby permitting a decoking cycle to be run on one or more selected off-stream tubing flow-paths, without disturbing the overall hydrocarbon pyrolysis process in the remaining on-stream tubes. Individual banks of tubes can be isolated, as disclosed in U.S. Pat. No. 8,864,977, which is incorporated herein by reference.

The first bank of convection tubes 115 includes one or more rows of tubes 171, 173 in fluid communication with one another. Each of the rows of tubes can act as heat exchangers, which exchange heat from the flue gas traveling in direction 112, perpendicular to each row of tubes, to the contents flowing through the tubes of the rows of tubes. Heat recovery exchangers 172, 174, such as economizers or steam superheaters, can be disposed adjacent to one or more of the heat exchangers 171, 173, such as in an alternating arrangement (relative to a vertical direction of the furnace 100). A heat recovery exchanger (also referred to as a “water service”), can be a waste heat recovery exchanger that discharges duty into a utility steam supply. An economizer can be a heat recovery exchanger that preheats water to increase steam production at, or downstream of, an outlet of the economizer, relative to a fluid flow within the economizer. A steam superheater can be a heat exchanger that superheats steam to convert existing generated steam into energy suitable for powering equipment such as major turbines. The heat recovery exchangers 172, 174 can receive water 170 such as from a boiler water source. Although each of the heat exchangers 171, 173 and each of the heat recovery exchangers 172, 174 are depicted as each having two rows partially traversing a diameter of the furnace 100, other arrangements and numbers of rows are also contemplated and can be utilized depending on different factors, such as feed flexibility, environmental, and operating conditions. Although the first pre-beating section 107 is depicted with an alternating heat recovery exchanger and heat exchanger arrangement, other arrangements are also contemplated such as alternating heat recovery exchangers and heat exchangers in the second pre-heating section 109. In some embodiments, a selective catalytic reduction bed (SCR) 180 for nitrogen oxide reduction is disposed between the first pre-heating section 107 and the second pre-heating section 109. Nitrogen oxides can be NO, NO₂, N₂O, or combinations thereof. An economizer can be placed above SCR 180 or below SCR 180. Placement of the economizer above or below the SCR 180 refers to physical positioning of the economizer such that hot flue gas is directed upwards such that rows above a heat exchanger use colder flue gas relative to rows below the respective heat exchanger. It has been discovered that placing an economizer directly above the SCR 180 provides increased temperatures of dry feed outlet temperature and in the hydrocarbon-containing feed in the first pre-heating section 107. This scheme is highly efficient because heat is delivered to the hydrocarbon-containing feed within the first pre-heating section 107 which reduces an amount of heat that is needed to promote steam-cracking of the hydrocarbon-containing feed as the feed travels through the furnace. Economizers placed below SCR 180 only increases dry feed outlet temperature required from already pinched dry hydrocarbon rows that are already operating close to desired temperatures. Economizers placed between dry hydrocarbon-containing rows does not increase row efficiency enough to justify increased mechanical complexity. Depending on types of hydrocarbon-containing feed, operating conditions, and furnace conditions, all arrangements are contemplated. For example, in the case of a feed preheat duty performed by the furnace effluent after steam generation (called a feed-preheat secondary TLE), some of the dry feed preheat duty is removed from the convection section. In place of the removed dry feed preheat duty is a larger economizer which consumes the same flue gas duty that the dry feed preheat would have performed if the duty was not removed from the convection section. Instead, the duty is provided in incremental boiler feed water preheat. The incremental boiler feed water preheat configuration has the advantage of an inexpensive flow scheme for an ethane cracker. In this case, the dry feed preheat can be disposed above the larger BFW economizer. The SCR bed can be disposed below the BFW economizer with no additional dry feed preheat before steam injection.

Pinch point placement refers to arranging the heat exchangers to restrict duty to reach predetermined targets or limit within targets. Pinch points refers to portions of the heat exchangers with the smallest difference in temperature.

The steam cracking furnace 100 includes a radiant section 113 downstream of the convection section 103. The convection section 103 includes the first heat exchanger 171 in fluid communication with a first section of a line. The convection section includes second heat exchanger 173 in fluid communication with the first section of the line and a second section of the line. The first economizer 172 is disposed in a first location between the first heat exchanger 171 and the second heat exchanger 173, the first economizer 172 in fluid communication with a water source 170. The second economizer 174 is disposed in a second location downstream of the second heat exchanger 173, the second economizer 174 in fluid communication with the first economizer 172.

The first heat exchanger 171 includes a first surface area and the second heat exchanger 173 includes a second surface area that is larger than the first surface area. The “surface area” of the heat exchangers refers to the inner surface of the tubes (e.g., 171, 173) that is exposed to (e.g., interfaces with) the flue gas. A ratio of the first surface area relative to the second surface area can be based on a predetermined heating rate of the hydrocarbon-containing feed disposed within each heat exchanger. By way of example, a first surface area can have a larger surface area relative to the second surface area to enable higher temperatures of the hydrocarbon-containing feed within the first heat exchanger 171 relative to the second heat exchanger. The surface area refers to the area of tube with which the hydrocarbon-containing feed within the tube can (indirectly) interact with the flue gas. A percentage of first surface area to total surface area (e.g., first and second surface area) can be about 30% to about 100%, such as about 35% to about 50%. The percentage can depend on relative temperature constraints of the furnace. In some embodiments, a hotter feed preheat entering the convection section will require less initial preheat above the economizer relative to a cooler feed preheat, and potentially less initial preheat than an economizer at the top of the furnace to minimize stack temperature. In some embodiments, a heavier feed like naphtha or crude will have lower maximum temperature before water or steam injection (e.g., lower dry temperature limits) than a lighter feed such as ethane. Lower maximum temperature can correspond to less dry feed preheat or may move more dry feed preheat area to above the economizer.

The first and second heat exchangers 171, 173 together include about 10 to about 20 rows of tubing and the first and second economizers 172, 174 together include about 4 to about 10 rows of tubing. Each number of rows of tubing can be determined based on the feed, stack 101 temperature, predetermined rate of heating of the hydrocarbon-containing feed, and/or other considerations. In some embodiments, the first heat exchanger 171 includes 2 rows to about 10 rows of tubing that are heated by the flue gas flow in direction 112. In some embodiments, the second heat exchanger includes about 5 rows to about 15 rows of tubing. In some embodiments, the tubing is from about 5.5 meters to 25 meters long. In some embodiments, the tubing has a nominal pipe size (NPS) of about 3 inches to about 8 inches.

In some embodiments, one or more economizers has a diameter that is the same or substantially the same as one more heat exchangers. In some embodiments, one or more economizers has a diameter that is equal to 2 inches greater than the diameter (NPS) of the one or more heat exchangers.

A total exterior surface area of the first economizer 172, the second economizer 174, the first heat exchanger 171, and the second heat exchanger 173 can be about 6,000 m² to about 18.000 m² The total exterior surface area depends on the size of the furnace, amount of or rate at which waste heat is to be recovered, and/or other considerations.

An apparatus 100 for processing hydrocarbon-containing feeds is provided including a convection section 103 and a radiant section 113 downstream of the convection section. The system is configured to flow flue gas in direction 112 from the radiant section 113 through the convection section. In particular, the flue gas direction 112 generally travels in an “upstream” direction.

The heated hydrocarbon-containing feed of line 133 can be mixed with primary dilution steam of line 137 and/or a fluid of line 135 such as a water. The fluid can be vapor, steam, liquid, or a mixture thereof. The mixing of the heated hydrocarbon-containing feed and the primary dilution steam of line 137 and/or fluid of line 135 can occur within or exterior to the pyrolysis furnace 100, such as outside the pyrolysis furnace 100 using any mixing device known within the art such as a double sparger assembly. The fluid of line 135 can enter a first sparger 102a of the double sparger assembly, which can avoid or reduce hammering caused by sudden vaporization of the fluid, upon introduction of the fluid into the heated hydrocarbon-containing feed.

A secondary dilution steam of line 141 can be heated in a first superheater tube bank 143 to produce a second separator feed 147. The source of the secondary dilution steam can be primary dilution steam that has been superheated, such as in the convection section 103 of the pyrolysis furnace 100. Either or both of the primary and secondary dilution steam streams can include sour or process steam. Superheating the sour or process dilution steam can reduce or eliminate the risk of corrosion from condensation of sour or process steam. The primary dilution steam of line 137 can be injected into a second sparger 102b of the double sparger assembly, and the resulting stream mixture of line 136 can enter the second bank of convection tubes 117 for additional heating with flue gas in traveling in direction 112 to produce a first separator feed 139. The first separator feed 139 can be mixed with the second separator feed 147 and introduced to a flash/liquid separator vessel 153 to produce two phases, including a vapor phase of line 155 and a liquid phase of line 157 The vapor phase of line 155 can include volatile hydrocarbons and steam. The liquid phase of line 157 can include non-volatile hydrocarbons, including coke precursors. The vapor phase can be fed to a lower convection section tube bank 119 in a second preheating zone 111 of the convection section 103. The second preheating zone 111 can be proximate to the radiant section 113 of the furnace, and the vapor phase can pass through crossover pipes 160 to the radiant section of the pyrolysis furnace for cracking into a radiant section effluent of line 162. The radiant section effluent of line 162 can be rapidly cooled in a transfer-line exchanger (“TLE”) 163, generating saturated steam which can be superheated in superheater convection section 120. The steam of the TLE can be used to drive large turbines or can be reintroduced to the furnace as dilution steam. In some embodiments, an ammonia injection grid system (AIG) 181 is disposed between the second pre-heating section 109 and the superheater convection section 120.

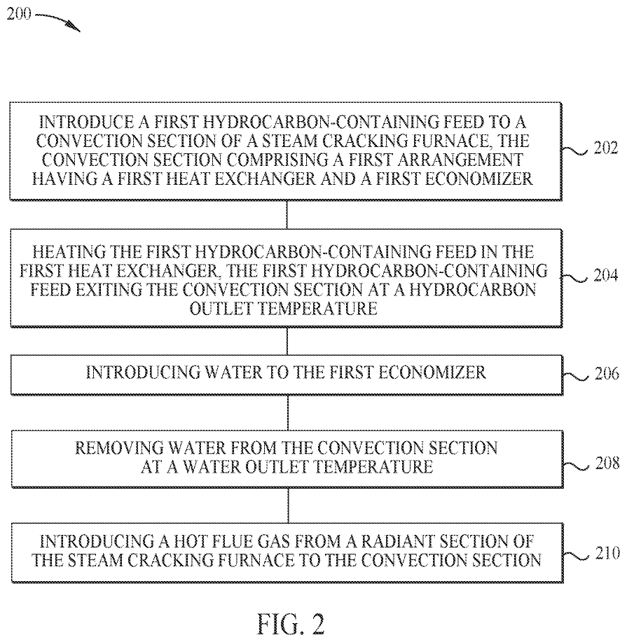

FIG. 2 depicts a flow diagram of a method 200 for processing hydrocarbons in accordance with some aspects of the present disclosure. The method 200 can include introducing 202 a first hydrocarbon-containing feed to a convection section of a steam cracking furnace. The convection section includes a first arrangement having a first heat exchanger and a first economizer disposed downstream or upstream of the first beat exchanger, of the first heat exchanger. The convection section has a second arrangement having a second heat exchanger in fluid communication with the first heat exchanger and a second economizer in fluid communication with the first economizer. The second arrangement is disposed downstream of the first arrangement such that each of the first and second economizer are disposed in an alternating pattern with each of the first and second heat exchangers.

Method 200 includes heating 202 the first hydrocarbon-containing feed in the first heat exchanger, the first hydrocarbon-containing feed exiting the convection section at a hydrocarbon outlet temperature. Method 200 includes introducing 206 water to the first economizer Method 200 includes removing 208 water from the convection section at a water outlet temperature. Method 200 includes introducing 210 a hot flue gas from a radiant section of the steam cracking furnace to the convection section. The second arrangement can be determined based on the hydrocarbon outlet temperature and the water outlet temperature of the convection section. The hot flue gas alternates contacting the economizers and heat exchangers (because of the alternating configuration of the economizers and heat exchangers) such that heat is exchanged between the flue gas and an economizer before and/or after heat is exchanged between the flue gas and a heat exchanger.

The first economizer is disposed downstream of the first heat exchanger. The second arrangement is determined based on operating parameters of the first hydrocarbon-containing feed processed in the furnace and a second hydrocarbon-containing feed to be processed in the furnace, where operating parameters include operating modes. An operating mode can include a cracking mode, a decoking mode, or a combination thereof.

The first heat exchanger includes a continuous convection tube in a serpentine pattern, the continuous convection tube comprising a plurality of substantially parallel rows. Determining the second arrangement of the convection section at 210 includes determining the number of parallel rows of the first heat exchanger to provide a surface area of the first heat exchanger based on the hydrocarbon outlet temperature. Increasing a number of parallel rows of the first heat exchanger increases the surface area of the first heat exchanger and increasing the surface area increases hydrocarbon outlet temperature. Likewise, decreasing a number of parallel rows of the first heat exchanger decreases the surface area of the first heat exchanger and decreasing the surface area decreases hydrocarbon outlet temperature.

A water outlet temperature of the economizer closest to the radiant section (e.g., second economizer 174) can be determined relative to a saturation temperature of the water at a given pressure. The water outlet temperature can be about 170° C. below saturation temperature to about saturation temperature, such as about 60° C. below saturation temperature, such as about 20° C. below saturation temperature. In some embodiments, the water outlet temperature can be about 160° C.′ to about 328° C., such as about 220° C.′ to about 280° C. The hydrocarbon outlet temperature of the second heat exchanger 173 (e.g., second hydrocarbon outlet of the second heat exchanger) is about 175° C. to about 390° C., such as about 200° C. to about 300° C. such as about 240° C. The hydrocarbon outlet temperature is based on a flue gas temperature, the surface area of one or more of the heat exchangers, the surface area of one or more of the heat recovery exchangers, the arrangement of the heat exchangers relative to the heat recovery exchangers, or a combination(s) thereof. The hydrocarbon outlet temperature (e.g., at 133) is within about 5° C. to about 30° C. of the water outlet temperature of the second economizer in at least one operating mode.

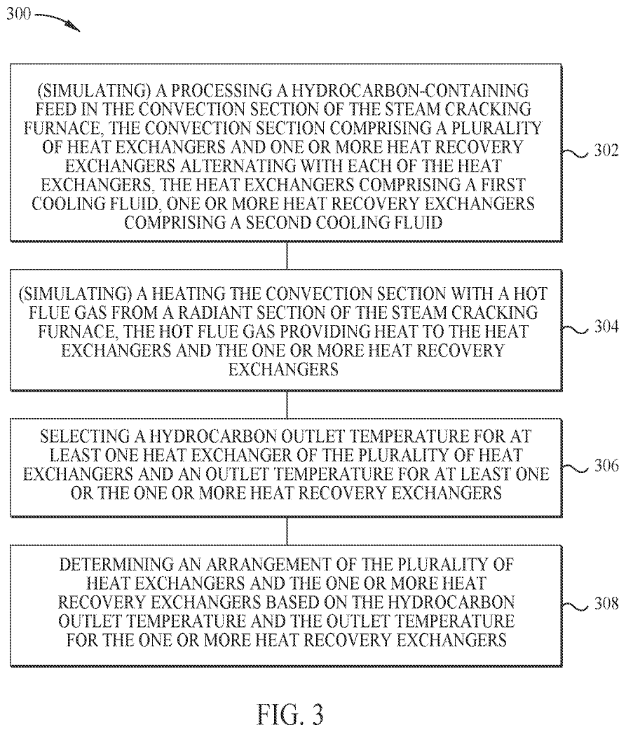

FIG. 3 depicts a flow diagram of an example method 300 for designing a steam cracking furnace in accordance with some aspects of the present disclosure. The method 300 can include (simulating) processing 302 a hydrocarbon-containing feed in the convection section of the steam cracking furnace. The convection section includes a plurality of heat exchangers and one or more heat recovery exchangers alternating with each of the heat exchangers. The heat exchangers include a first cold fluid. The heat recovery exchangers include a second cold fluid.

Method 300 includes (simulating) heating 304 the convection section with a hot flue gas from a radiant section of the steam cracking furnace. The hot flue gas provides heat to the heat exchangers and the one or more heat recovery exchangers.

Method 300 includes selecting 306 a hydrocarbon outlet temperature for at least one heat exchanger of the plurality of heat exchangers and an outlet temperature for at least one of the one or more heat recovery exchangers.

Method 300 includes determining 308 an arrangement of the plurality of heat exchangers and the one or more heat recovery exchangers based on the hydrocarbon outlet temperature and the outlet temperature for the one or more heat recovery exchangers Determining the arrangement of the plurality of heat exchangers and the one or more heat recovery exchangers can be based on determining a log mean temperature difference (LMTD) of each of the heat exchangers and the heat recovery exchanger for countercurrent flow between hot flue gas and cold side fluids, wherein the LMTD is determined by Equation 1 below:

$$LMTD = \frac{( {T}_{h , in} - {T}_{c , out} ) - ( {T}_{h , out} - {T}_{c , in} )}{ln ( ( ( {T}_{h , in} - {T}_{c , out} ) / ( {T}_{h , out} - {T}_{c , in} )} , \qquad Equation 1$$

where:

T_{h,in} is a hot inlet temperature of the hot flue gas entering each heat exchanger or heat recovery exchanger, T_{h,out} is a hot outlet temperature of the hot fluid exiting the heat exchangers or heat recovery exchanger. T_{c,in} is a cold inlet temperature of the first or second cold fluid entering the heat exchangers or heat recovery exchangers, T_{c,out} is a cold outlet temperature of the first or second cold fluid exiting the heat exchangers or heat recovery exchangers. The LMTD is a function of temperature difference across which heat is exchanged such that as the temperature difference diminished with accumulated heat transfer, the rate of heat transfer diminishes. Equation 1 represents an LMTD relationship for counter-current exchangers, such as the heat exchangers described herein.

In some embodiments, the arrangement of the plurality of heat exchangers and the one or more heat recovery exchangers can further be based on adjusting, such as minimizing a total surface area of the convection section. The total surface area can be substantially equal to a total interface area between hot flue gas and the first and second cold fluids. In some embodiments, a surface area of one or more heat exchangers or one or more heat recovery exchangers provides adjusting a duty (Q) of the one or more heat exchangers or one or more heat recovery exchangers. Each of the one or more heat recovery exchangers can be selected from an economizer, a steam superheater, a water exchanger, or combination(s) thereof. As used herein, “duty (Q).” refers to a heat transfer rate measured in W or J/s.

Adjusting a duty (Q) of one or more of the heat exchangers and/or the heat recovery exchangers can be simulated by calculating the LMTD of one or more of the heat exchangers and/or the heat recovery exchangers using the LMTD equation shown in Equation 1.

Each duty of each of the heat exchangers and the heat recovery exchangers is related to each interface area (A) of each interface between hot flue gas and first and second cold fluids and each LMTD for each of the heat exchangers and the heat recovery exchangers by an energy equation, Equation 2:

$$Q = U \times A \times LMTD , \qquad Equation 2$$

where Q is duty. U is heat transfer coefficient. A is interface area, and LMTD is log mean temperature difference.

The heat transfer coefficient (U) is determined based one or more parameters such as flue gas stagnant film thickness, flue gas stagnant film conductivity, flue gas fouling resistance, heat exchanger or economizer wall thickness, heat exchanger or economizer wall conductivity, extended surface efficiency, cold fluid fouling resistance, cold fluid stagnant film thickness, cold fluid stagnant film conductivity, and combination(s) thereof. The heat transfer coefficient can have units of Watts/meter²Kelvin. The heat transfer area (A) can be adjusted for cylindrical heat transfer components or extended surfaces.

The first heat recovery exchanger can be disposed upstream of the first heat exchanger or downstream of the first heat exchanger. The second cold fluid can be introduced from the heat recovery exchanger to a steam generator heat exchanger to form steam. In some embodiments, the steam is introduced to the convection section to form a superheated steam. The steam can be introduced to the convection section downstream of the first and second heat exchanger.

The method 300 can be performed by one or more computers or computer systems. As such, it will be understood that the method 300 can be at least partially computer-executed, including using a processor, or by manipulation by the processor via electrical signals representing data in a structured form. The method can be implemented in hardware, software, and/or firmware and/or a combination thereof. The manipulation transforms the data to computer models used to simulate process design parameters, such as furnace component arrangement and component sizes. The data can include hydrocarbon properties and characteristics that is to be fed to the furnace. The transformation of the data can include user entered principles, such as mathematical relationships (e.g., equations 1 and 2), scientific theories or laws, furnace limitations, environmental considerations, and other considerations. The computer models can access additional data from one or more libraries located on a server or the memory.

In some embodiments, (simulating) processing 302 a hydrocarbon-containing feed in the convection section of the steam cracking furnace includes simulating processing 302 the hydrocarbon-containing feed using one or more computers or computer systems.

In some embodiments, (simulating) heating 304 the convection section with a hot flue gas from a radiant section of the steam cracking furnace includes simulating heating 304 the convection section with the hot flue gas using one or more computers or computer systems.

### Decoking and Cracking Operations

Systems and methods of the present disclosure can provide the flexibility of running a furnace (e.g., furnace 100) during normal cracking operations as well as during decoking operations. During a cracking operation, various internal contact surfaces of the pyrolysis furnace can accumulate “coke” such as in the radiant section 161. Coke can be removed in a decoking operation, where the decoking operation can include operating parameters for individual tube banks such as the superheater convection section 200, to allow decoking of the radiant section 161. The decoking operation can include operating the furnace in a decoking mode and allowing TLE steam to generate in the TLE 264 while cooling the flue gas (of direction 112). In a split operation referred to herein as “on-stream decoking,” a portion of the furnace, such as a thermal cracking tube, can be isolated and decoked while other portions continue to operate in cracking mode.

The cracking mode can have a first set of operating conditions including flue gas rates, TLE flow rates, and steam temperatures. In some embodiments, the first set of operating conditions includes flue gas flow rate of about 150 tons per hour (“tph”) to about 350 tph, such as from about 200 tph to about 300 tph, such as about 250 tph.

The decoking mode can have a second set of points including flue gas rates, TLE flow rates, and steam temperatures. In some embodiments, the second set of operating conditions for decoking mode includes flue gas flow rate of about 40 tph to about 60 tph, such as about 45 tph to about 55 tph, such as about 50 tph. In some embodiments, the second set of operating conditions can also be used for steam standby mode. Steam standby mode refers to a transition to and from decoking and as a standby condition that can be maintained for hours to days and readily changed to decoking or cracking mode. As modes change, the operating conditions change and are managed by adjusting controls to keep temperatures within the rest of the furnace components within range. In particular, the temperature is managed for one or more of the stack temperature, SCR 180 inlet temperature, AIG 181 inlet temperature, separator 153 inlet temperature, first separator feed 139 temperature, vapor phase stream 160 temperature, superheater convection section 120, first pre-heating section 107, second pre-heating section 109, and/or an outlet of one or more of the heat recovery exchangers (e.g., 172, 174). In some embodiments, the SCR 180 is coupled to the inner sidewall of the furnace and occupies a portion of the volume of the convection section such that flue gas is passed through the SCR 180 without bypassing the SCR 180.

The weight ratio of flue gas rates from cracking mode to decoking mode can be from about 2:1 to about 7:1, such as about 4:1 to about 6:1, such as about 5:1. In some embodiments, three different operation modes include: 1) a high superheated steam flow rate with low duty cracking mode (e.g., for cracking recycle gas such as ethane) having saturated steam feed rates of about 66 tph: 2) a low superheated steam flow rate with high duty cracking mode (e.g., for cracking crude) having saturated steam feed rates of about 20 to about 40 tph; and 3) a very low saturated steam flow rate and high comparative flue gas flow rate decoking mode having saturated steam feed rates of about 40 tph to about 50 tph, such as about 48 tph. Operation mode 1 (e.g., cracking recycle gas) can have an inlet flue gas temperature of about 700° C. to about 1100° C. such as about 800° C. to about 1000° C., such as about 900° C. Operation mode 2 (e.g., cracking crude) can have an inlet flue gas temperature of about 675° C. to about 1075° C., such as about 775° C. to about 975° C., such as about 877° C. Operation mode 1 and 2 are both cracking modes. In some embodiments, operation mode 1 can have inlet flue gas temperatures about 5° C. to about 40° C., such as about 10° C. to about 30° C., such as about 23° C. higher than the inlet flue gas temperatures of operation mode 2. In some embodiments, operation mode 1 can have flue gas flow rates about 1% to about 5%, such as about 2% to about 4%, such as about 3% higher than operation mode 2 and operation mode 1 can have saturated steam feed rates that are about 1.5 to about 2.5, such as about 2.2 times greater than operation mode 2. Increasing the temperature of the flue gas can improve flexibility for decoking operations in which decoking operating (e.g., operation mode 3) can have a flue gas temperature about 150° C. to about 200° C. different from the cracking modes and a ratio of the flue gas flow to process flow can be substantially different from the cracking operation. The ratio of flue gas flow to process flow (e.g., hydrocarbon-containing feed flow) can affect heat transfer and result in slower or faster cooling of the flue gas as the flue gas travels upstream in direction 112. The ratio of flue gas flow to process flow can also affect temperatures of furnace components upstream of the superheater convection section.

It has also been contemplated that methods of the present disclosure can be performed by a programed system having an algorithm stored in a memory of the system. The algorithm can include a number of instructions which, when executed by a processor, can cause the method described herein to be performed.

### EXAMPLE

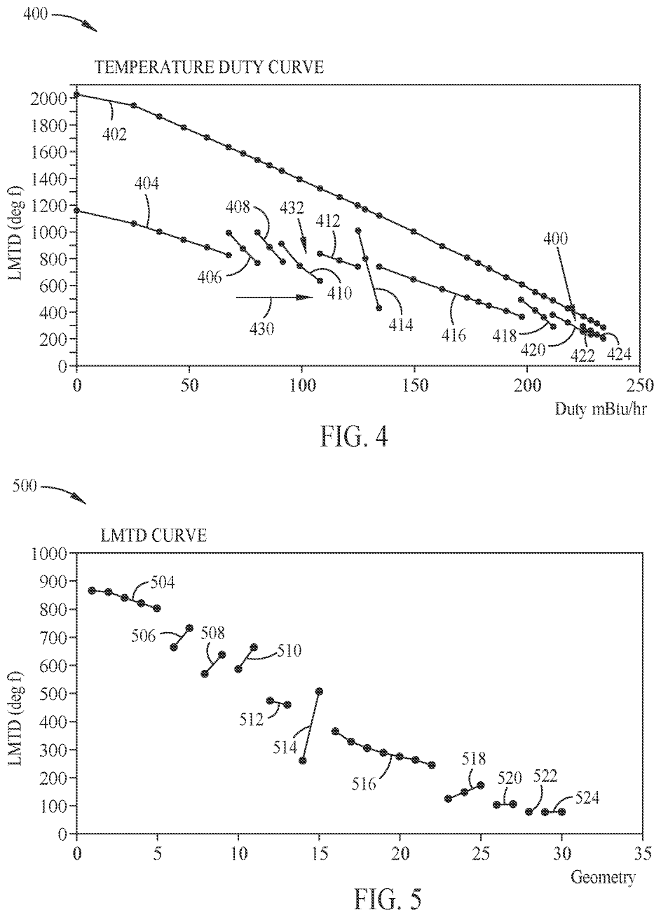

FIG. 4 depicts temperature duty curves for various effluents of a steam cracking furnace for a crude cracking feed. FIG. 5 depicts the corresponding LMTD curves. The flue gas curve 402 is depicted alongside curves of various components of the convection section (e.g., 404, 406, 408, 410, 412, 414, 416, 418, 420, 422, 424). Based on the analysis of the curves, the components are arranged to increase efficiency of heat transfer, such as through convective heating from the flue gas to heat exchangers and heat recovery exchangers. If a gap is shown, such as gap 432, the services such as those depicted by 406, 408, 410, each can be shifted or rearranged in a direction 430 to close the heat transfer gap 432. Components 406, 408, and 410 can be one or more superheaters shown in superheater section 111. Moreover, “pinch points” (e.g., 440) can be created to further increase heat transfer efficiency. As used herein, a “pinch point” refers to the location within the heat exchange network (e.g., one or more heat exchangers) where the hot side and cold side temperature difference is at a minimum with respect to the remainder of the heat exchange network. The pinch points can be identified as locations in which a temperature duty curve for a hot side of a heat exchange area that is within about 10%, such as within about 5% of a temperature duty curve for a cold side of a heat exchange area. In particular, a first dry hydrocarbon heat exchanger having 6 rows of tubing (e.g., represented by curve 424) is disposed adjacent to a first economizer having 2 rows of tubing (e.g., represented by curve 422). The first hydrocarbon heat exchanger is in fluid communication with second dry hydrocarbon heat exchanger having 10 rows of tubing (e.g., represented by curve 420). The second dry hydrocarbon heat exchanger 420 is disposed between the first economizer and a second economizer having four rows of tubing. The second economizer 418 is in fluid communication with the first economizer 422.

Each of the component curves of FIG. 4 correspond to LMTD curves 504, 506, 508, 510, 512, 514, 516, 518, 520, 522, 524 depicted in FIG. 5. The horizontal axis is a “geometry” or arrangement of heat transfer elements, each geometry can have one or more rows of tubing arranged within the convection section arranged parallel with respect to one another and each substantially perpendicular to a flue gas direction. The LMTD curve can be arranged such as a substantially continuous curve is formed as shown in FIG. 5.

The arrangement provides more flexibility and furnace sustainability. Arrangement of components can be provided to achieve increased or decreased slopes of the duty or LMTD curves while minimizing an amount of tubing surface area. This is illustrated in Tables 1 and 2 shown below. Table 1 provides an example of an alternating dry hydrocarbon (HC) and boiler feed water (BFW) economizer arrangement. In order to achieve a second economizer outlet temperature of 483° F. and a second dry hydrocarbon outlet temperature of 375° F., a total heat exchange area (A) of about 139,483 ft² is needed, which was calculated from Equations 1 and 2 (above). Table 2 provides an illustration of a single economizer and a single dry feed preheat arrangement for processing the same crude feed as the arrangement depicted in Table 1.

As can be seen, in order to achieve an economizer outlet temperature of 483° F. and a dry hydrocarbon outlet temperature of 375° F., a total heat exchange area (A) of about 154,960 ft² is needed. This is about 11% more outside tube surface area that is needed for the same amount of heat transfer than the dual economizer embodiment.

Table 3 depicts a single economizer and single dry feed preheat arrangement processing crude with the same heat exchange area as of 139,483 ft²depicted in Table 1. However, at about the same heat exchange area, the dry hydrocarbon outlet temperature is 367° F., which is about 2% lower than the embodiment of Table 1. Correspondingly, the flue gas outlet temperature is about 293° F. versus about 282° F., resulting in reduced waste heat recovery and lower efficiency by 350 KW (1.3 MBTU/hr).

TABLE 1
Crude, Dual Economizer and Dual Dry Feed Preheat Alternating Arrangement

| | | Dry | Dry | BFW | Dry | Dry | BFW | BFW | BFW |
|---|---|---|---|---|---|---|---|---|---|
| | | HC #1 | HC #1 | Econ #1 | HC #2 | HC #2 | Econ #2 | Econ #2 | Econ #2 |
| Geometry | — | 30 | 29 | 28 | 27 | 26 | 25 | 24 | 23 |
| Duty (QMM) | mBtu/hr | 2.72 | 2.74 | 3.45 | 6.62 | 6.92 | 4.06 | 3.6 | 6.12 |
| Flue Gas Inlet Temp. (TFGI) | ° F. | 306 | 331 | 361 | 419 | 478 | 513 | 543 | 596 |
| Flue Gas Outlet Temp. (TFGO) | ° F. | 282 | 306 | 331 | 361 | 419 | 478 | 513 | 543 |
| Process Outlet Temp. (TPRO) | ° F. | 228 | 254 | 291 | 315 | 375 | 351 | 402 | 483 |
| Process Inlet Temp. (TPRI) | ° F. | 201 | 228 | 240 | 254 | 315 | 292 | 351 | 402 |
| Overall Factor (U) | Btu/(Hr · ft² · ° F.) | 1.879 | 1.949 | 3.004 | 2.078 | 2.211 | 3.25 | 3.305 | 3.367 |
| LMTD | ° F. | 80 | 78 | 80 | 106 | 104 | 173 | 151 | 126 |

| | | |
|---|---|---|
| Total Area | ft² | 139,483 |

TABLE 2
Single Economizer and Single Dry Feed Preheat Arrangement

| | | Dry | BFW |
|---|---|---|---|
| | | HC | Economizer |
| Geometry | — | 26 | 23 |
| Duty (QMM) | mBtu/hr | 19 | 17.23 |
| Flue Gas Inlet Temp. (TFGI) | ° F. | 446.8 | 596 |
| Flue Gas Outlet Temp. (TFGO) | ° F. | 284.8 | 446.8 |
| Process Outlet Temp. (TPRO) | ° F. | 375 | 483 |
| Process Inlet Temp. (TPRI) | ° F. | 201 | 240 |
| Overall Factor (U) | Btu/(Hr · ft² · ° F.) | 2.03 | 3.23 |
| LMTD | ° F. | 77.6 | 155.2 |
| Area | ft² | 120587 | 34354 |

TABLE 3
Single Economizer and Single Dry Feed Preheat Arrangement

| | | Dry | BFW |
|---|---|---|---|
| | | HC | Economizer |
| Geometry | — | 26 | 23 |
| Duty (QMM) | mBtu/hr | 19 | 17.23 |
| Flue Gas Inlet Temp. (TFGI) | ° F. | 446.8 | 596 |
| Flue Gas Outlet Temp. (TFGO) | ° F. | 292 | 446.8 |
| Process Outlet Temp. (TPRO) | ° F. | 367.3 | 483 |
| Process Inlet Temp. (TPRI) | ° F. | 201 | 240 |
| Overall Factor (U) | Btu/(Hr · ft² · ° F.) | 2.03 | 3.23 |
| LMTD | ° F. | 85.1 | 155.2 |
| Area | ft² | 105162 | 34355 |

Similar calculations for gas feed provided that a single economizer and single dry feed preheat case results in 42% more outer surface area of the tube to achieve the same heat transfer. Moreover, at the same amount of surface area a single economizer and single dry feed preheat arrangement compromised both the economizer and the dry hydrocarbon outlet temperatures. The dry hydrocarbon outlet temperature was reduced by 2.8% and economizer outlet temperature was reduced by 1.3%.

The economizer layout including positioning, number of rows, and diameter can be selected to maximize steam production during cracking while minimizing recycle gas steam production. Thus, a range in steam temperatures or desuperheater rates is minimized by arranging the pinch points to minimize steam production on one feed and maximize steam production on another feed and bring the two curves closer together. In particular, the economizers can be arranged such that the process conditions are LMTD limited on recycle gas and area limited on crude feed such that the two corresponding curves are within about 10% of one another.

The economizer arrangement is determined based on the relative amount of dry feed rate, water flow to supply steam generated, and flue gas flow available. In some embodiments, for a crude cracking furnace operating in naphtha cracking mode, operating conditions include a high dry feed rate, a high steam production, and, relative to other modes and/or feed types, low flue gas rate. In some embodiments, a crude cracking furnace in crude cracking mode has a high dry feed rate, low steam production, such as due to fouling of the TLE, and, relative to other conditions, a low flue gas rate. In some embodiments, a crude cracking furnace in decoking mode has a very low dry feed rate (steam and air), very low steam production (due to fouling of the TLE and low dry feed rate), and very high flue gas rate, relative to other conditions. The alternating arrangements for each embodiment reduces the extremes from the cases by pinching the flue gas temperature with the preheated temperature of the dry feed or economizer. In some embodiments, if an excess of flue gas is produced and not enough steam production, such as in a decoke mode, the pinched economizer reduces the imbalance by “disabling” some of the economizer area. In some embodiments, if a large amount of dry feed is introduced, high steam production, and low flue gas rate (naphtha feed case) then the dry feed rows reduce this imbalance by pinching at the top of the convection section against the flue gas. This effectively disables some of this excess dry feed row area in this operating mode. The arrangements and techniques for flexibility are particularly useful for a crude cracker.

The economizer arrangements described herein are also useful for minimizing heat transfer area in an ethane cracker.

Overall, methods of arranging hot and cold services are provided, such as heat exchangers and heat recovery exchangers to control duty of a convection section of a steam cracking furnace. The steam cracking furnace has alternating heat exchangers and heat recovery exchangers provide processing a wide array of types of feeds and provides reduced stack temperatures that are released from the furnace. Reduced stack temperatures reduces environmental impact from gases released to the environment.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

The following listing of claims replaces the previous version of claims:

1. A steam cracking process comprising:
introducing a first hydrocarbon-containing feed to a convection section of a steam cracking furnace, the convection section comprising a first arrangement having a first heat exchanger and a first economizer disposed downstream or upstream of the first heat exchanger, the convection section comprising a second arrangement having a second heat exchanger in fluid communication with the first heat exchanger and a second economizer in fluid communication with the first economizer, the second arrangement disposed downstream of the first arrangement such that each of the first and second economizer alternates with each of the first and second heat exchangers;
heating the first hydrocarbon-containing feed in the first heat exchanger, the first hydrocarbon-containing feed exiting the convection section at a hydrocarbon outlet temperature;
introducing water to the first economizer;
removing the water from the convection section at a water outlet temperature; and
introducing a hot flue gas from a radiant section of the steam cracking furnace to the convection section.

2. The process of claim 1, wherein the first economizer is disposed downstream of the first heat exchanger.

3. The process of claim 1, wherein the first heat exchanger comprises a continuous convection tube in a serpentine pattern, the continuous convection tube comprising a plurality of substantially parallel rows.

4. The process of claim 1, wherein:
a water outlet temperature of the second economizer is about 160° C. to about 328° C., and
the second hydrocarbon outlet temperature is about 175° C. to about 390° C.

5. The process of claim 1, wherein the second hydrocarbon outlet temperature is within about 5° C. to about 30° C. of the water outlet temperature of the second economizer in at least one operating mode.

6. A process of designing a steam cracking furnace comprising:
simulating a processing of a hydrocarbon-containing feed in a convection section of a steam cracking furnace, the convection section comprising a plurality of heat exchangers and one or more heat recovery exchangers alternating with each of the heat exchangers, one or more of the heat exchangers comprising a first cooling fluid, and one or more of the heat recovery exchangers comprising a second cooling fluid;
simulating a heating of the convection section with a hot flue gas from a radiant section of the steam cracking furnace, the hot flue gas providing heat to the heat exchangers and the one or more heat recovery exchangers;
selecting a hydrocarbon outlet temperature for at least one heat exchanger of the plurality of heat exchangers and an outlet temperature for at least one of the one or more heat recovery exchangers; and
determining an arrangement of the plurality of heat exchangers and the one or more heat recovery exchangers based on the hydrocarbon outlet temperature and the outlet temperature of the one or more heat recovery exchangers.

7. The process of claim 6, wherein the determining the arrangement is further based on minimization of a total surface area of the convection section, wherein the total surface area is substantially equal to a total interface area between hot flue gas and the first and second cold fluids.

8. The process of claim 7, further comprising adjusting a duty of at least one of the heat exchangers and the heat recovery exchangers by adjusting the total surface area of the convection section.

9. The process of claim 6, wherein the one or more heat recovery exchangers is selected from the group consisting of an economizer, a steam superheater, a water exchanger, and combination(s) thereof.

10. The process of claim 6, further comprising determining a log mean temperature difference (LMTD) of at least one of the heat exchangers and at least one of the heat recovery exchangers, wherein the LMTD is determined by an equation:
$$LMTD = \frac{( {T}_{h , in} - {T}_{c , out} ) - ( {T}_{h , out} - {T}_{c , in} )}{ln ( ( {T}_{h , in} - {T}_{c , out} ) / ( {T}_{h , out} - {T}_{c , in} ) )} ,$$
wherein T_{h,in} is a hot inlet temperature of the hot flue gas entering each heat exchanger or heat recovery exchanger, T_{h,out} is a hot outlet temperature of the hot fluid exiting the heat exchangers or heat recovery exchanger, T_{c,in} is a cold inlet temperature of the first or second cooling fluid entering the heat exchangers or heat recovery exchangers, T_{c,out} is a cold outlet temperature of the first or second cooling fluid exiting the heat exchangers or heat recovery exchangers.

11. The process of claim 10, further comprising adjusting a duty of one or more of the heat exchangers and/or one or more of the heat recovery exchangers by adjusting the LMTD of one or more of the heat exchangers and/or one or more of the heat recovery exchangers.

12. The process of claim 10, wherein each duty of each of the heat exchangers and the heat recovery exchangers is related to each interface area (A) of each interface between hot flue gas and first and second cold fluids and each LMTD for each of the heat exchangers and the heat recovery exchangers by an energy equation:
$$Q = U \times A \times LMTD ,$$
wherein U is heat transfer coefficient.

13. The process of claim 12, further comprising calculating heat transfer coefficient (U) based one or more parameters selected from the group consisting of:
flue gas stagnant film thickness;
flue gas stagnant film conductivity;
flue gas fouling resistance;
heat exchanger or economizer wall thickness;
heat exchanger or economizer wall conductivity;
extended surface efficiency;
cooling fluid fouling resistance;
cooling fluid stagnant film thickness;
cooling fluid stagnant film conductivity; and
combination(s) thereof.

14. The process of claim 13, wherein the convection section comprises two heat exchangers and two heat recovery exchangers.

15. The process of claim 13, further comprising:
introducing the second cooling fluid in the heat recovery exchanger to a steam generator heat exchanger to form steam; and
introducing the steam to the convection section to form a superheated steam.

16. A steam cracking furnace comprising a convection section and a radiant section downstream of the convection section, the convection section comprising:
a first heat exchanger in fluid communication with a first section of a line;
a second heat exchanger in fluid communication with the first section of the line and a second section of the line;
a first economizer disposed in a first location between the first heat exchanger and the second heat exchanger, the first economizer in fluid communication with a water source; and
a second economizer disposed in a second location downstream of the second heat exchanger, the second economizer in fluid communication with the first economizer.

17. The furnace of claim 16, wherein the first heat exchanger comprises a first surface area and the second heat exchanger comprises a second surface area, wherein the second surface area is larger than the first surface area.

18. The furnace of claim 16, wherein the first and second heat exchangers together comprise about 10 to about 20 rows of tubing and the first and second economizers together comprise about 4 to about 10 rows of tubing.

19. The furnace of claim 16, wherein a total exterior surface area of the first economizer, the second economizer, the first heat exchanger, and the second heat exchanger is about 6,000 m² to about 18,000 m².

20. A system for processing hydrocarbons comprising:
a convection section,
a radiant section downstream of the convection section, the system configured to flow flue gas from the radiant section through the convection section, the convection section comprising:
a first economizer in fluid communication with a boiler water feed;
a second economizer in fluid communication with the first economizer and a steam drum;
a first heat exchanger in fluid communication with a hydrocarbon source, the first heat exchanger disposed between the first economizer and the second economizer; and
a second heat exchanger in fluid communication with the first heat exchanger, the second heat exchanger disposed downstream of the second economizer.

21. The system of claim 20, wherein the hydrocarbon source is a light hydrocarbon or a crude oil source.

22. The system of claim 20, wherein the total exterior surface area of the first economizer, second economizer, first heat exchanger, and second heat exchanger is about 6,000 m² to about 18,000 m².

23. The system of claim 20, wherein the first heat exchanger comprises about 2 rows to about 10 rows of tubing and the second heat exchanger comprises about 5 rows to about 15 rows of tubing.

24. The system of claim 20, wherein total tubing has a length of about 5.5 meters to about 25 meters, the total tubing defined as tubing of each of the first economizer, the second economizer, the first heat exchanger, and the second heat exchanger.

25. A process of designing a steam cracking furnace comprising:
simulating a processing of a hydrocarbon-containing feed in a convection section of a steam cracking furnace, the convection section comprising a plurality of heat exchangers and one or more heat recovery exchangers alternating with each of the heat exchangers, one or more of the heat exchangers comprising a first cooling fluid, and one or more of the heat recovery exchangers comprising a second cooling fluid;
simulating a heating of the convection section with a hot flue gas from a radiant section of the steam cracking furnace, the hot flue gas providing heat to the heat exchangers and the one or more heat recovery exchangers;
selecting a hydrocarbon outlet temperature for at least one heat exchanger of the plurality of heat exchangers and an outlet temperature for at least one of the one or more heat recovery exchangers; and
determining an arrangement of the plurality of heat exchangers and the one or more heat recovery exchangers based on a target selected from the group consisting of:
furnace operating mode;
hydrocarbon-containing feed type;
furnace fouling condition;
selective catalytic reduction bed (SCR) temperature;
an ammonia injection grid temperature;
stack temperature;
steam superheater intermediate temperature of at least 100° F. above a saturation temperature of the steam;
steam superheater outlet temperature;
heat recovery exchanger outlet temperature; and combinations thereof.
